(19) United States
(12) Patent Application Publication
(10) Pub. No.: US 2014/0187379 A1
(43) Pub. Date: Jul. 3, 2014

(54) DRIVE DEVICE OF HOSPITAL BED, HOSPITAL BED, AND MAGNETIC RESONANCE IMAGING SYSTEM

(71) Applicant: Siemens Aktiengesellschaft, Munchen (DE)

(72) Inventors: QI XING CHEN, SHENZHEN (CN); TING QIANG XUE, SHENZHEN (CN); XU YAN, SHENZHEN (CN)

(73) Assignee: SIEMENS AKTIENGESELLSCHAFT, Munchen (DE)

(21) Appl. No.: 14/108,652

(22) Filed: Dec. 17, 2013

(30) Foreign Application Priority Data
Dec. 27, 2012 (CN) 201210578411.X

(51) Int. Cl. A61G 7/018

(52) U.S. Cl. CPC A61G 7/018
USPC 477/12

(57) ABSTRACT

A drive device of a hospital bed, a hospital bed, and a magnetic resonance imaging system are disclosed. The drive device includes: a first power interruption component, connected to a first transmission mechanism, and used for controlling power supply of the first transmission mechanism, where the first transmission mechanism is used for driving a bed body of the hospital bed to move in a first direction. A second power interruption component is connected to a second transmission mechanism, and used for controlling power supply of the second transmission mechanism, where the second transmission mechanism is used for driving the bed body to move in a second direction. The device also includes a motor, where the motor is connected to the first power interruption component and the second power interruption component; and a controller, used for controlling the motor, the first power interruption component, and the second power interruption component.

### CROSS-REFERENCE TO RELATED APPLICATIONS

This application claims the benefit of and priority to Chinese application No. CN201210578411.X, filed Dec. 27, 2012 under 35 U.S.C. §119, the entire contents of which are hereby incorporated by reference.

### FIELD OF TECHNOLOGY

The following relates to medical devices, and particularly relates to a drive device of a hospital bed, a hospital bed, and a magnetic resonance imaging system.

### BACKGROUND

A patient table (PTAB) is a core component for medical examination devices such as a magnetic resonance imaging (MRI) device and a computed tomography (CT) device. The patient table (also known as a hospital bed, an examining table, etc.) has basic functions of carrying or supporting a patient and moving the patient to a predetermined examination position. The PTAB can move the patient to an imaging center and provide position information required by measurement. The horizontal movement of a bed body of the patient table can be driven by a motor drive device. In addition, the PTAB can move downwards to a lower height so that a patient can conveniently move to the bed surface, and this vertical movement may also be achieved by a motor drive device. In the prior PTAB art, the movement along each direction is achieved by a separate motor and a separate controller.

Since the cost of electrical and transmission components accounts for a larger proportion of the material cost of a PTAB, employing a separate motor and a separate controller in a horizontal direction and a vertical direction greatly increases cost. Moreover, it also incurs cost to take an electromagnetic compatibility (EMC) measure between two independent drive devices. Further, it requires space and corresponding structures to mount all components (including each drive device) so that a medical examination device occupies a larger space.

Based on the work flow of a medical examination device (e.g. a MRI device, etc.), the vertical movement and the horizontal movement of a PTAB always occur sequentially rather than simultaneously. The horizontal movement occurs only when a bed body reaches a working height and the vertical movement occurs only when the bed body is in an origin position. In a current MRI system, an approach to saving the cost of a drive device is to optimize mechanical transmission components of horizontal and vertical drive devices, or to select different mechanical transmission components for the horizontal and vertical drive devices, or to reduce functions of the PTAB (for example, to disable the vertical movement, etc.). However, the above approach may achieve very limited effects.

### SUMMARY

In view of this, the invention provides a drive device of a hospital bed, a hospital bed, and a magnetic resonance imaging system, thereby reducing the cost of the device.

To achieve the above a technical solution of the invention is realized specifically as follows:

One embodiment of the invention provides a drive device of a hospital bed, comprising:

a first power interruption component connected to a first transmission mechanism and used for controlling power supply of the first transmission mechanism, wherein the first transmission mechanism is used for driving a bed body of the hospital bed to move in a first direction;

a second power interruption component connected to a second transmission mechanism and used for controlling power supply of the second transmission mechanism, wherein the second transmission mechanism is used for driving the bed body to move in a second direction;

a motor connected to the first power interruption component and the second power interruption component; and

a controller used for controlling the motor, the first power interruption component and the second power interruption component.

One embodiment of the invention provides a hospital bed, comprising: a bed body, a first transmission mechanism, a second transmission mechanism, and the drive device as described above.

One embodiment of the invention provides a magnetic resonance imaging system, comprising: the hospital bed as described above.

As seen above, the drive device of a hospital bed, the hospital bed, and the magnetic resonance imaging system provided by the embodiments of the invention are capable of reducing the cost of equipment so that the equipment is more competitive in cost. Further, a PTAB employing the drive device has a compact structure, a small size and a light weight.

The above solutions, technical features, advantages and their implementation ways of the invention are to be further described below in a clear and understandable manner through the description of the embodiments in conjunction with the drawings.

### BRIEF DESCRIPTION

Some of the embodiments will be described in detail, with reference to the following figures, wherein like designations denote like members, wherein:

FIG. 1 is a schematic view of a hospital bed;

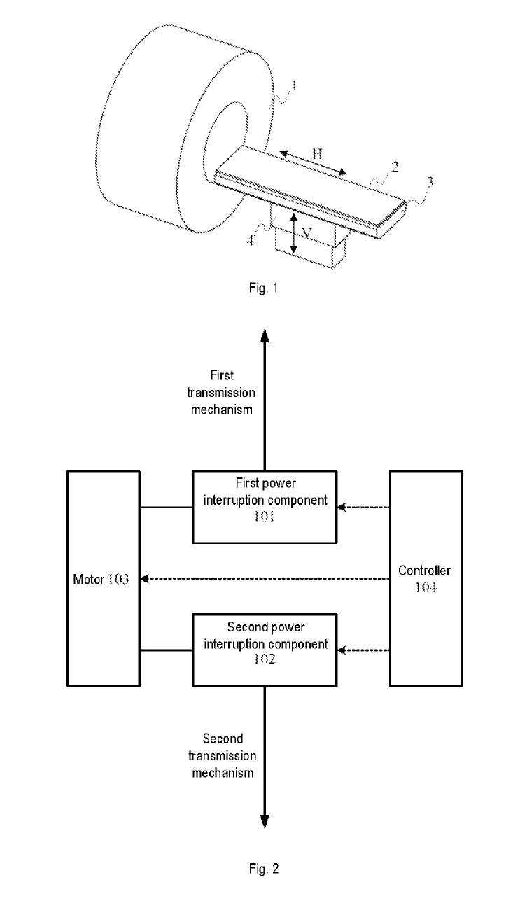

FIG. 2 is a schematic view illustrating the principle of a drive device of a medical examination device in one embodiment;

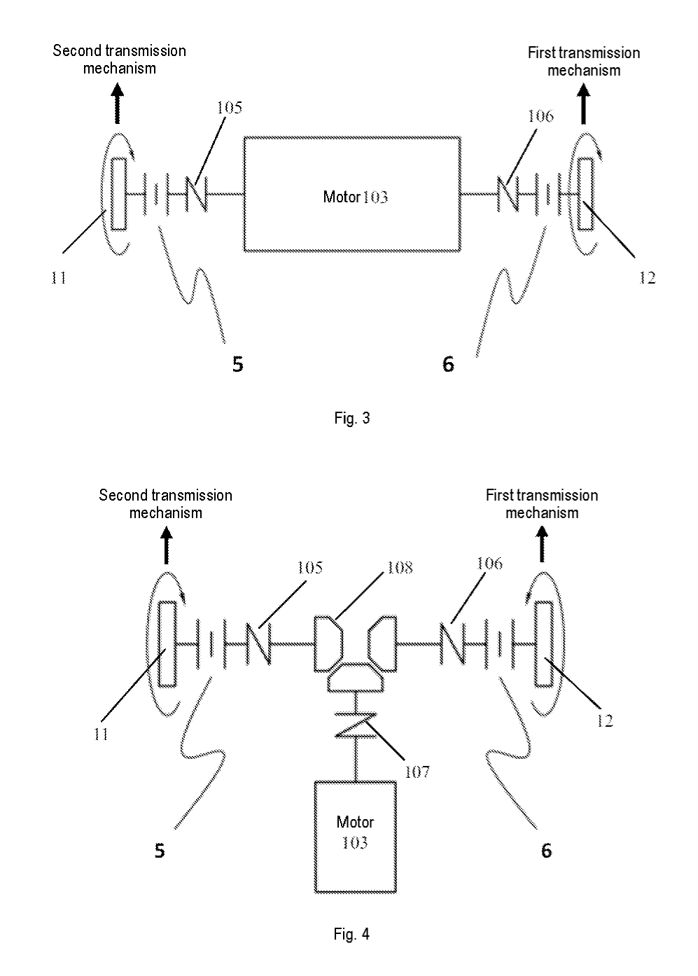

FIG. 3 is a schematic view of the composition of a drive device employing a double-shaft motor in one embodiment;

FIG. 4 is a schematic view of the composition of a drive device employing a motor placed along a radial direction in one embodiment;

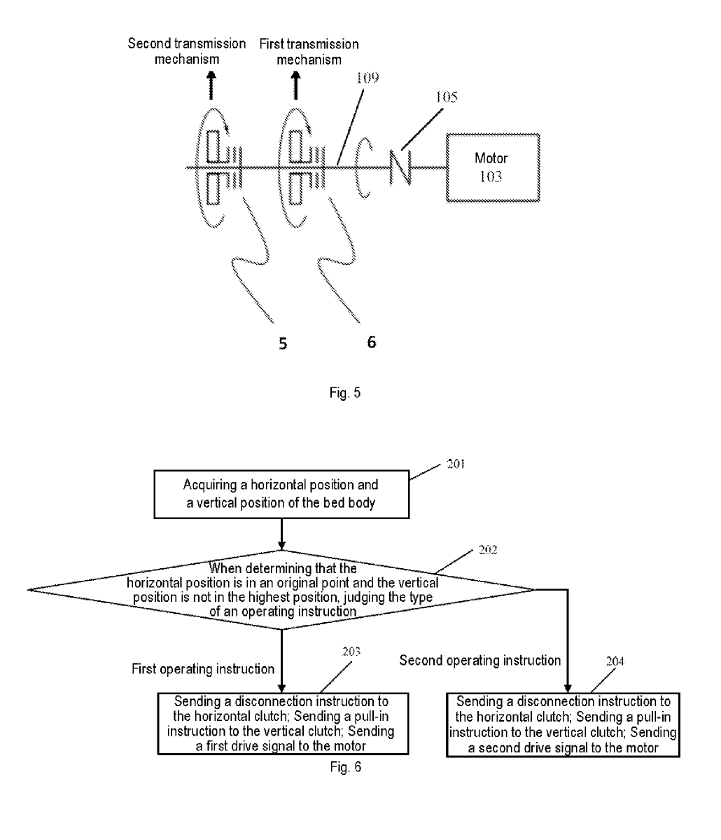

FIG. 5 is a schematic view of the composition of a drive device employing a motor placed at one side in one embodiment;

FIG. 6 is a work flow chart where a controller performs motion control on a PTAB in one embodiment;

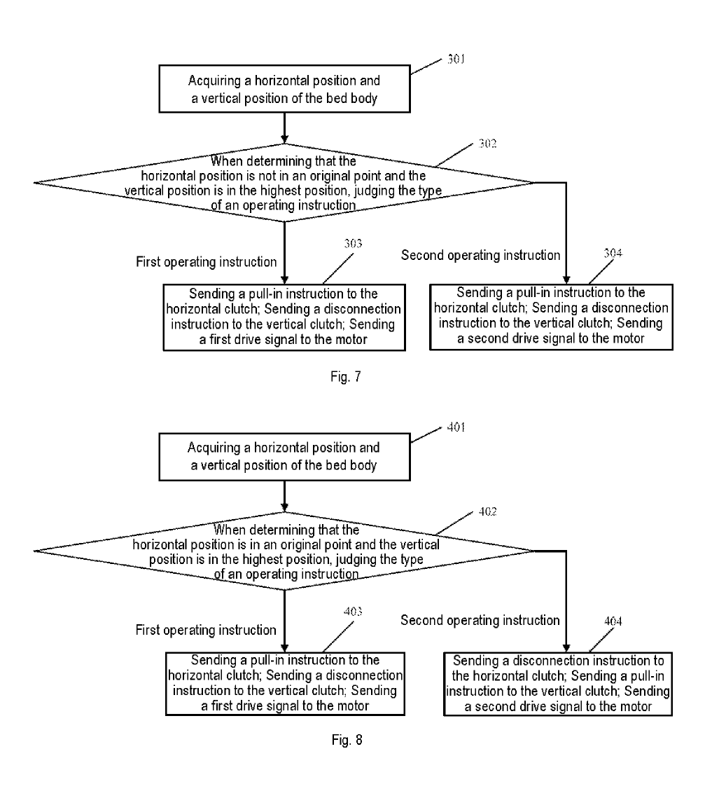

FIG. 7 is a work flow chart where a controller performs motion control on a PTAB in one embodiment;

FIG. 8 is a work flow chart where a controller performs motion control on a PTAB in one embodiment;

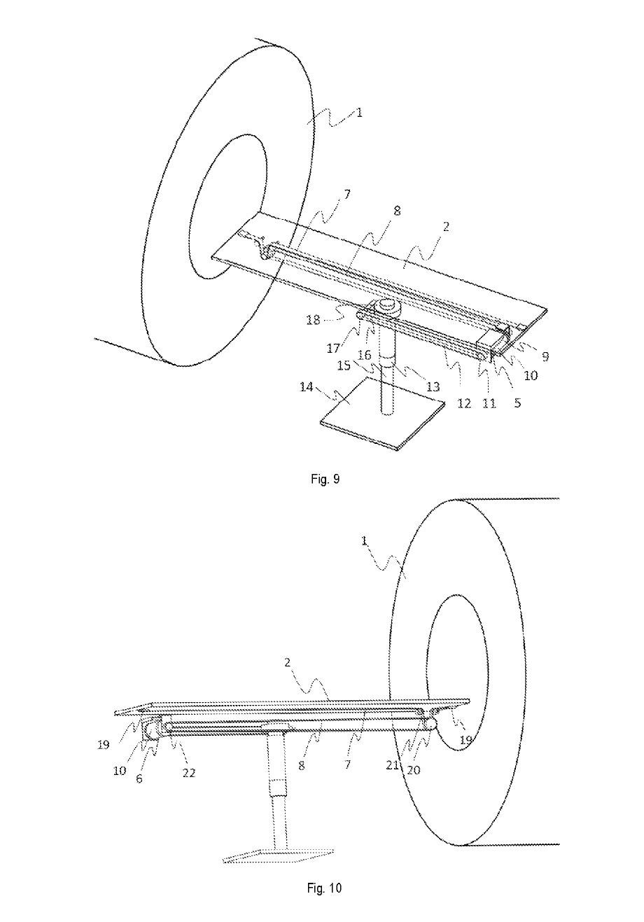

FIG. 9 is a structural view of the composition of a vertical transmission mechanism in one embodiment; and

FIG. 10 is a structural view of the composition of a horizontal transmission mechanism in one embodiment.

Particularly, reference numerals used in the above drawings are as follows: scanning component 1; bed body 2; bed frame 3; and support column 4; first power interruption component 101; second power interruption component 102; motor 103; and controller 104; vertical clutch 5; horizontal clutch 6; couplings 105, 106, 107; vertical belt pulley 11; and horizontal belt pulley 22; gear case 108; and main shaft 109; omega belt 7; horizontal belt 8; motor bracket 9; double-shaft motor 10; vertical clutch 5; vertical belt pulley 11; vertical belt 12; worm belt pulley 17; worm 16; worm wheel 18; nut 13; spindle 15; and base plate 14; double-shaft motor 10; horizontal clutch 6; horizontal belt pulley 22; horizontal belt 8; central belt pulley 20; eccentric roller 21; omega belt 7; and belt plate 19.

### DETAILED DESCRIPTION

In order to make the technical solutions and advantages of the invention clearer, the invention is to be further described below in detail with reference to the drawings and embodiments.

FIG. 1 shows the composition of a PTAB in a medical examination device by taking an MRI system as an example, wherein the PTAB comprises a scanning component 1 (for example, a circular hollow magnet in the MRI system), a bed body 2, a bed frame 3 and a support column 4. The bed body 2 for carrying a patient is placed on the bed frame 3 which is fixed on the support column 4 for supporting the bed body 2. The bed body 2 can move inwards and outwards in a horizontal direction while the bed frame 3 does not move horizontally. Particularly, horizontally inward movement is to allow the bed body 2 to approach or enter into the scanning component 1 (or to depart from an original point) while horizontally outward movement is to allow the bed body 2 to be away from the scanning component 1 (or to move to the original point). The support column 4 is driven by a motor to move along a vertical direction, thereby driving the bed body 2 to move up and down in the vertical direction. Functions that can be realized by the PTAB include horizontal movement of the bed body 2, and vertical movement of the bed body 2 driven by vertical movement of the support column 4. Particularly, the horizontal movement of the bed body 2 is driven by a first transmission mechanism while the vertical movement of the bed body 2 is driven by a second transmission mechanism.

Correspondingly, as shown in FIG. 2, an embodiment of the invention provides a drive device, comprising: a first power interruption component 101 connected to a first transmission mechanism and used for controlling power supply of the first transmission mechanism, wherein the first transmission mechanism is used for driving a bed body of a hospital bed to move in a first direction; a second power interruption component 102 connected to a second transmission mechanism and used for controlling power supply of the second transmission mechanism, wherein the second transmission mechanism is used for driving the bed body to move in a second direction; a motor 103 connected to the first power interruption component 101 and the second power interruption component 102; and a controller 104 used for controlling the motor 103, the first power interruption component 101, and the second power interruption component 102.

The first direction is orthogonal to the second direction. Particularly, the first direction is a direction which is parallel to the ground and in which the bed body moves inwards and outwards relative to a scanning component in a medical examination device, i.e. the first direction is a length direction of the hospital bed, and the second direction is a direction which is parallel to the ground and in which the bed body moves left and right relative to the scanning component. Alternatively, the first direction is parallel to the ground, and the second direction is perpendicular to the ground.

It should be noted that the first direction is radial and the second direction is axial with reference to the bed body 2 in one specific implementation. Furthermore, the direction represented by H in FIG. 1 can be set as Z axis, the direction represented by V in FIG. 1 can be set as Y axis and the direction orthogonal to Z axis on the horizontal plane of the bed body 2 can be set as X axis to establish a three-dimensional coordinate system. In one specific implementation, the first direction is an X-axis direction and the second direction is a Z-axis direction, i.e. the motor 103 controls the bed body 2 to move left and right (X axis) or inwards and outwards (Z axis) on the horizontal plane relative to the scanning component 1. In another specific implementation, the first direction is an X-axis direction and the second direction is a Y-axis direction, i.e. the motor 103 controls the bed body 2 to move left and right (X axis) on the horizontal plane or vertically (Y axis). In yet another specific implementation, the first direction is a Z-axis direction and the second direction is a Y-axis direction, i.e. the motor 103 controls the bed body 2 to move inwards and outwards (Z axis) on the horizontal plane or vertically (Y axis). Indeed, the first direction and the second direction only function as reference and also are interchangeable, for example, the first direction is a Z-axis direction and the second direction is an X-axis direction, but this is not limited in the embodiments of the invention.

In one specific example, the first power interruption component 101 and the second power interruption component 102 can be clutches or gear cases. The controller 104 sends a control signal such as high and low level to the motor 103, the first power interruption component 101 and the second power interruption component 102, thereby controlling the motor 103 to drive the bed body 2 to move in a corresponding direction, controlling the clutches to be disconnected or pulled in, or controlling input gears of the gear cases to be engaged with a first power interruption gear or a second power interruption gear thereof, as shown in FIG. 2 in dotted lines. The motor 103 is driven by the controller 104 to perform forward and reverse movement. Under the control of the first power interruption component 101, the motor 103 supplies power to the first transmission mechanism or interrupts the power supply to the first transmission mechanism. Similarly, under the control of the second power interruption component 102, the motor 103 supplies power to the second transmission mechanism or interrupts the power supply to the second transmission mechanism.

In one embodiment, the motor 103 comprises a first output shaft and a second output shaft; and the first output shaft is connected to an input shaft of the first power interruption component, and the second output shaft is connected to an input shaft of the second power interruption component.

In one embodiment, the motor 103 comprises at least one output shaft. The output shaft is connected to a first gear case; and the first gear case is connected to input shafts of the first power interruption component and the second power interruption component respectively. Alternatively, the output shaft is connected to a transmission main shaft; and the input shafts of the first power interruption component and the second power interruption component are respectively connected to the transmission main shaft.

Particularly, FIG. 3 provides a schematic view of the composition of a drive device in one embodiment of the invention, wherein the embodiment is exemplified by taking the first direction as a Z-axis direction and the second direction as a Y-axis direction. The drive device employs a double-shaft motor 103, a first output shaft of the motor 103 is connected to a first power interruption component and a second output shaft of the motor 103 is connected to a second power interruption component. For example, each output shaft of the motor 103 is connected with one electromagnetic clutch and output shafts of the two clutches are respectively connected to a first transmission mechanism and a second transmission mechanism. The motor 103 is connected to a vertical clutch 5 via a coupling 105 and connected to a horizontal clutch 6 via a coupling 106. The vertical clutch 5 and the horizontal clutch 6 have different working modes. When powered on, the vertical clutch is pulled in while the horizontal clutch is disconnected. When a PTAB moves vertically, both the horizontal clutch and the vertical clutch are powered on. At this time, the vertical clutch is pulled in so that the power or rotating speed of the motor is transferred to the second transmission mechanism; and meanwhile, the horizontal clutch is disconnected so that the motor does not drive the first transmission mechanism. Vice versa, i.e. the horizontal movement process of the PTAB is contrary to the above vertical movement. In another specific implementation, the vertical clutch 5 and the horizontal clutch 6 with the same working mode can be employed, i.e. both the vertical clutch 5 and the horizontal clutch 6 are pulled in when powered on and disconnected when powered off.

FIG. 4 is a schematic view of the composition of a drive device in one embodiment of the invention, wherein the embodiment is exemplified by taking the first direction as a Z-axis direction and the second direction as a Y-axis direction. A motor employed by the drive device is a single-shaft motor 103 placed along a radial direction. The motor 103 is a universal motor, an output shaft of which is connected to a gear case 108 respectively connected to input shafts of a first power interruption component and a second power interruption component. In one specific implementation, the motor 103 is connected to the gear case 108 via a coupling 107 and respectively connected to input shafts of two clutches via the gear case 108; and the gear case 108 can be a reversing gear case. As described in the example in FIG. 3, a vertical clutch 5 and a horizontal clutch 6 employ different working modes. When a PTAB moves vertically, power is simultaneously supplied to the vertical clutch 5 and the horizontal clutch 6. At this time, the vertical clutch 5 is pulled in so that the power of the motor is supplied to a second transmission mechanism. When the PTAB is switched to horizontal movement, both of the two clutches are not powered on, and the horizontal clutch 6 is pulled in while the vertical clutch 5 is disconnected so that the power of the motor is supplied to a first transmission mechanism.

FIG. 5 is a schematic view of the composition of a drive device in one embodiment of the invention, wherein the embodiment is exemplified by taking the first direction as a Z-axis direction and the second direction as a Y-axis direction. The drive device employs a universal single-shaft motor 103 and an output shaft of the motor 103 is connected to a main shaft 109 via a coupling 105. Input shafts of a vertical clutch 5 and a horizontal clutch 6 are connected to the main shaft 109 which is driven by the rotation of the motor. When powered on, both the vertical clutch 5 and the horizontal clutch 6 are pulled in. When a PTAB moves vertically, power is supplied to the vertical clutch only, so the vertical clutch is pulled in. The rotation or torque of the main shaft is delivered to a second transmission mechanism via the vertical clutch that has been pulled in. On the contrary, when power is supplied to the horizontal clutch and a power source of the vertical clutch is cut off, the power of the motor is delivered to a first transmission mechanism so that the bed body moves horizontally. Indeed, in the embodiment, the vertical clutch 5 and the horizontal clutch 6 with different working modes also can be employed. Correspondingly, when the PTAB needs to be controlled for vertical movement, a controller simultaneously sends a power-on signal to the vertical clutch 5 and the horizontal clutch 6, and the vertical clutch is pulled in while the horizontal clutch is disconnected; and when the PTAB needs to be controlled for horizontal movement, the controller simultaneously sends a power-off signal to the vertical clutch 5 and the horizontal clutch 6, and the vertical clutch is disconnected while the horizontal clutch is pulled in.

Although FIGS. 3-5 do not clearly show the controller 104, it should be noted that the rotation of the motor 103 is controlled by the controller 104 and power sources of the two clutches 5 and 6 are turned on or off by the controller 104.

In one embodiment of the invention, the first power interruption component 101 and the second power interruption component 102 can be one gear case. Particularly, the gear case can be a gear case capable of shifting gear, which comprises a gear shift mechanism, an input gear, a first power interruption gear and a second power interruption gear. The first power interruption component 101 is corresponding to the first power interruption gear and the second power interruption component 102 is corresponding to the second power interruption gear. When the gear shift mechanism drives the input gear to engage with the first power interruption gear, it means that the first power interruption component 101 is in a connecting state, and at the moment the first transmission mechanism obtains the power of the motor. When the gear shift mechanism drives the input gear to engage with the second power interruption gear, the second power interruption component 102 is connected so that the second transmission mechanism obtains the power of the motor. It should be noted that the gear shift operation of the gear case capable of shifting gear is controlled by the controller 104.

Particularly, the controller acquires position information of the bed body, and respectively sends a control instruction to the first power interruption component, the second power interruption component and the motor according to an operating instruction and the position information. Take FIGS. 6-8 for example below to specify how the controller controls the movement of the bed body of the PTAB according to the state of a travel switch and an operating instruction.

FIG. 6 is a work flow chart of the controller in one embodiment of the invention, wherein the embodiment is exemplified by taking the first direction as a Z-axis direction and the second direction as a Y-axis direction.

In step 201, the controller acquires a horizontal position and a vertical position of the bed body. In one specific implementation, the PTAB is equipped with two travel switches, i.e. a highest-position switch and an origin switch, wherein the highest-position switch is used for detecting whether the bed body of the PTAB reaches the highest position and the origin switch is used for detecting whether the bed body is in an origin position. When the PTAB is in the highest position, the highest-position switch is triggered and its state is set to be off. When the highest-position switch is in an on state, the PTAB is away from the highest position. The origin position is a position where the bed body is farthest from the scanning component 1, and the origin switch is in an off state at the moment. If the bed body approaches the scanning component 1, the origin switch is opened.

In step 202, the controller determines that the horizontal position is in an original point and the vertical position is not in the highest position. At this time, the controller receives an operating instruction which is sent by an operator pressing a button on the medical examination device.

For the case that the horizontal position is in the origin position and the vertical position is not in the highest position, the origin switch is in an off state and the highest-position switch is in an on state, indicating that the PTAB can move vertically. In one specific implementation, a first operating instruction is an upward/inward instruction and a second operating instruction is a downward/outward instruction. Alternatively, the first operating instruction is an operating instruction to move upwards vertically and the second operating instruction is an operating instruction to move downwards vertically.

In step 203, when the controller determines that the operating instruction is the first operating instruction, the controller sends a disconnection instruction to the horizontal clutch, sends a pull-in instruction to the vertical clutch and sends a first drive signal to the motor. Consequently, the power produced by the motor is output to the second transmission mechanism, thereby driving the bed body to move upwards vertically.

In step 204, when the controller determines that the operating instruction is the second operating instruction, the controller sends a disconnection instruction to the horizontal clutch, sends a pull-in instruction to the vertical clutch and sends a second drive signal to the motor. Consequently, the power produced by the motor is output to the second transmission mechanism, thereby driving the bed body to move downwards vertically.

In the above process, the precedence order of the steps 201 and 202 is not particularly limited. The controller also can first receive the operating instruction and then acquire the position information of the bed body, or both of the operations are performed simultaneously. It should be noted that the precedence order of receiving the operating instruction and acquiring the position information of the bed body is not limited in the following various processes yet.

FIG. 7 is a work flow chart of the controller in one embodiment of the invention, wherein the embodiment is exemplified by taking the first direction as a Z-axis direction and the second direction as a Y-axis direction.

In step 301, a horizontal position and a vertical position of the bed body are acquired. This step is similar to the step 201 and therefore is no longer described in detail herein.

In step 302, when it is determined that the horizontal position is not in an original point and the vertical position is in the highest position, the controller judges the type of an operating instruction received. At this time, the origin switch is in an on state and the highest-position switch is in an off state, indicating that the PTAB can move horizontally.

In step 303, when the operating instruction is determined to be a first operating instruction, a pull-in instruction is sent to the horizontal clutch, a disconnection instruction is sent to the vertical clutch and a first drive signal is sent to the motor, thereby driving the bed body to move inwards horizontally. Herein, the first operating instruction is an upward/inward instruction, or an operating instruction to depart from the original point.

In step 304, when the operating instruction is determined to be a second operating instruction, a pull-in instruction is sent to the horizontal clutch, a disconnection instruction is sent to the vertical clutch and a second drive signal is sent to the motor, thereby driving the bed body to move outwards horizontally. In one specific implementation, the second operating instruction can be a downward/outward instruction, or an operating instruction to move to the original point.

FIG. 8 is a work flow chart of the controller in one embodiment of the invention, wherein the embodiment is exemplified by taking the first direction as a Z-axis direction and the second direction as a Y-axis direction.

In step 401, a horizontal position and a vertical position of the bed body are acquired.

In step 402, when it is determined that the horizontal position is in an original point and the vertical position is in the highest position, the controller receives an operating instruction. At this time, the origin switch is in an off state and the highest-position switch is also in an off state.

In step 403, when the operating instruction is determined to be a first operating instruction, a pull-in instruction is sent to the horizontal clutch, a disconnection instruction is sent to the vertical clutch and a first drive signal is sent to the motor, thereby driving the bed body to move inwards horizontally. Herein, the first operating instruction is an upward/inward instruction, or an operating instruction to depart from the original point.

In step 404, when the operating instruction is determined to be a second operating instruction, a disconnection instruction is sent to the horizontal clutch, a pull-in instruction is sent to the vertical clutch and a second drive signal is sent to the motor, thereby driving the bed body to move downwards vertically. Herein, the second operating instruction is a downward/outward instruction, or an operating instruction to move downwards vertically.

For the case that the horizontal position is not in the origin position and the vertical position is not in the highest position, the highest-position switch is in an on state and the origin switch is also in an on state, and then the controller determines that the travel switches are out of order, and therefore does not send a control instruction.

For the case that the first power interruption component 101 and the second power interruption component 102 are the same gear case, the controller performs the following operations:

a horizontal position and a vertical position of the bed body are acquired; when the horizontal position is not in the origin position and the vertical position is in the highest position, the type of an operating instruction is determined; when the operating instruction is a first operating instruction (for example, an upward/inward instruction), a first reversing instruction is sent to the second gear case to allow an input gear of the second gear case to be engaged with a first power interruption gear so that the first power interruption component 101 is in a connecting state, and a first drive signal is sent to the motor to drive the bed body to move inwards horizontally; and when the operating instruction is a second operating instruction (for example, a downward/outward instruction), the first reversing instruction is sent to the second gear case to allow the input gear of the second gear case to be engaged with the first power interruption gear, and a second drive signal is sent to the motor to drive the bed body to move outwards horizontally.

Alternatively, the controller performs the following operations: a horizontal position and a vertical position of the bed body are acquired; when the horizontal position is in the origin position and the vertical position is not in the highest position, the type of an operating instruction is determined; when the operating instruction is a first operating instruction, a second reversing instruction is sent to the second gear case to allow an input gear of the second gear case to be engaged with a second power interruption gear so that the second power interruption component 102 is in a connecting state, and a first drive signal is sent to the motor to drive the bed body to move upwards vertically; and when the operating instruction is a second operating instruction, the second reversing instruction is sent to the second gear case to allow the input gear of the second gear case to be engaged with the second power interruption gear, and a second drive signal is sent to the motor to drive the bed body to move downwards vertically.

Alternatively, the controller performs the following operations: a horizontal position and a vertical position of the bed body are acquired; when the horizontal position is in the origin position and the vertical position is in the highest position, the type of an operating instruction is determined; when the operating instruction is a first operating instruction, a first reversing instruction is sent to the second gear case to allow an input gear of the second gear case to be engaged with a first power interruption gear, and a first drive signal is sent to the motor to drive the bed body to move inwards horizontally; and when the operating instruction is a second operating instruction, a second reversing instruction is sent to the second gear case to allow the input gear of the second gear case to be engaged with a second power interruption gear, and a second drive signal is sent to the motor to drive the bed body to move downwards vertically.

FIG. 9 is a schematic view of the composition of a vertical transmission mechanism in a PTAB employing a single-motor drive device in one embodiment of the invention, wherein the embodiment is exemplified by taking the first direction as a Z-axis direction and the second direction as a Y-axis direction. For the convenience of description, a bed body 2 is shown in a perspective manner. Vertical movement is achieved by the rotation of a nut 13 matching a spindle 15. The spindle 15 is fixed on a base plate 14 of a support column 4 of the PTAB and the nut 13 is connected with a worm wheel 18. A vertical clutch 5 is integrated on one output shaft of a motor 10, and together with the motor, is mounted on a bed frame 3 of the PTAB via a motor bracket 9. A vertical belt pulley 11 is mounted on an output shaft of the vertical clutch 5.

When the PTAB performs a vertical movement, the vertical clutch 5 is pulled in so that the rotation of the motor is delivered to the vertical belt pulley 11. Subsequently, the rotation is delivered to a worm belt pulley 17 via a vertical belt 12. Next, the rotation of the motor is delivered to the worm wheel 18 via a worm 16 and the worm wheel 18 drives the nut 13 for rotation. The rotating nut 13 matches the spindle 15, thereby achieving the vertical movement of the PTAB.

FIG. 10 is a schematic view of the composition of a horizontal transmission mechanism in a PTAB employing a single-motor drive device in one embodiment of the invention, wherein the embodiment is exemplified by taking the first direction as a Z-axis direction and the second direction as a Y-axis direction. An input shaft of a horizontal clutch 6 is connected to another output shaft of a double-shaft motor 10. Subsequently, a horizontal belt pulley 22 delivers the rotation of the motor to a central belt pulley 20 via a horizontal belt 8. Horizontal movement of a bed body is achieved by an omega belt drive structure which comprises the following parts: a central belt pulley 20, an eccentric roller 21, an omega belt 7 and a belt plate 19. The central belt pulley 20 is a center supporting shaft and has two belt pulleys with different diameters. The eccentric roller 21 is used for driving a synchronous belt and adjusting the tension of a belt. The omega belt 7 is folded into an omega shape by the central belt pulley 20 and the eccentric roller 21. The belt plate 19 fixes both ends of the omega belt 7 at the bottom of the bed body.

When the PTAB moves horizontally, power sources of a vertical clutch 5 and a horizontal clutch 6 are turned off, so the vertical clutch is disconnected and the horizontal clutch is pulled in. The rotation is delivered to a big belt pulley in the central belt pulley 20 via the horizontal belt 8. Subsequently, a small belt pulley in the central belt pulley 20 drives the omega belt 7 and finally drives the bed body to move horizontally.

FIGS. 9 and 10 only take a double-shaft motor as an example to respectively illustrate a schematic view where a vertical transmission mechanism and a horizontal transmission mechanism in a PTAB are connected with the drive device provided by an embodiment of the invention. It should be noted that the double-shaft motor 10, the vertical clutch 5 and the vertical belt pulley 11 in FIG. 9 as well as the horizontal clutch 6 and the horizontal belt pulley 22 in FIG. 10 also can be replaced by the component structures shown in FIG. 4 or 5.

In addition, for the case that the first direction is an X-axis direction and the second direction is a Y-axis direction, the horizontal transmission mechanism shown in FIG. 9 or 10 can be employed to drive the bed body to move in the X-axis direction and the vertical transmission mechanism shown in FIG. 9 or 10 can be employed to drive the bed body to move in the Y-axis direction. For the case that the first direction is an X-axis direction and the second direction is a Z-axis direction, a horizontal transmission mechanism shown in FIG. 9 or 10 can be set for the movement in the X-axis direction to drive the bed body to move left and right on the horizontal plane; and a horizontal transmission mechanism shown in FIG. 9 or 10 can be set for the movement in the Z-axis direction to drive the bed body to move inwards and outwards on the horizontal plane. Particularly, the vertical transmission mechanism can convert the rotation of the motor into an up and down straight-line motion of the bed body in a vertical direction via a spindle and the like; and the horizontal transmission mechanism can convert the rotation of the motor into a straight-line motion of the bed body on the horizontal plane via a synchronous belt or gear rack, etc.

It can be seen that, in the drive device of the medical examination device provided by an embodiment of the invention, a controller is shared in the horizontal movement and vertical movement of the bed body of the PTAB. Furthermore, a motor for driving the bed body to move horizontally and vertically also may be shared. That is to say, the drive device provided by an embodiment of the invention drives the PTAB using a single motor and a relevant controller, thereby realizing two-way movement. Accordingly, the PTAB needs not to be equipped with a vertical motor and a corresponding controller thereof as well as other fittings arranged for vertical movement, for example, an electrical drive, a power supply unit, an intermediate transmission component, etc., thereby saving a lot of cost. Further, most of the above components are originally mounted on a carrying frame of the PTAB. In the drive device provided by an embodiment of the invention, the vertical motor and its corresponding matching components can be omitted so that the space previously occupied by these components is released, thereby providing the PTAB with a more compact structure and reducing the total weight of the PTAB. Further, since the PTAB provided by an embodiment of the invention is compact in structure, reduced in size and lightened in weight, fewer materials are required, thereby better saving cost.

Further, an embodiment of the invention also provides a hospital bed, comprising: a bed body, a first transmission mechanism, a second transmission mechanism, and the drive device as shown in the above FIGS. 1-10.

Further, an embodiment of the invention also provides a magnetic resonance imaging system, comprising: the hospital bed as described above.

Indeed, the embodiments of the invention can be realized by different types of mechanical structures, electrical drives and controls, though one or more embodiments of the invention are shown in the drawings only. The invention is presented and described above in detail through the drawings and embodiments, but is not limited to these disclosed embodiments, so other schemes deduced by those skilled in the art therefrom are also within the protection scope of the invention.

1. A drive device of a hospital bed, comprising:
a first power interruption component, connected to a first transmission mechanism, and used for controlling power supply of the first transmission mechanism, wherein the first transmission mechanism is used for driving a bed body of the hospital bed to move in a first direction;
a second power interruption component, connected to a second transmission mechanism, and used for controlling power supply of the second transmission mechanism, wherein the second transmission mechanism is used for driving the bed body to move in a second direction;
a motor, connected to the first power interruption component (101) and the second power interruption component; and
a controller, used for controlling the motor, the first power interruption component, and the second power interruption component.

2. The drive device according to claim 1, wherein the first direction is orthogonal to the second direction.

3. The drive device according to claim 2, wherein the first direction and the second direction are parallel to the ground, and the first direction is a length direction of the hospital bed.

4. The drive device according to claim 2, wherein the first direction is parallel to the ground, and the second direction is perpendicular to the ground.

5. The drive device according to claim 1, wherein the motor comprises a first output shaft and a second output shaft; and
the first output shaft is connected to an input shaft of the first power interruption component, and the second output shaft is connected to an input shaft of the second power interruption component.

6. The drive device according to claim 1, wherein an output shaft of the motor is connected to a first gear case; and
the first gear case is connected to input shafts of the first power interruption component and the second power interruption component respectively.

7. The drive device according to claim 1, wherein an output shaft of the motor is connected to a transmission main shaft; and
the transmission main shaft is connected to input shafts of the first power interruption component and the second power interruption component respectively.

8. The drive device according to claim 1, wherein the controller is used for:
acquiring position information of the bed body; and
controlling the first power interruption component, the second power interruption component, and the motor according to an operating instruction and the position information.

9. The drive device according to claim 8, wherein the first power interruption component is a horizontal clutch, and the second power interruption component is a vertical clutch; and
the controller is used for:
acquiring a horizontal position and a vertical position of the bed body;
when the horizontal position is in an original point, and the vertical position is not in the highest position, receiving the operating instruction;
when the operating instruction is a first operating instruction, controlling the horizontal clutch to be disconnected, controlling the vertical clutch to be pulled in, and controlling the motor to drive the bed body to move upwards vertically; and
when the operating instruction is a second operating instruction, controlling the horizontal clutch to be disconnected, controlling the vertical clutch to be pulled in, and controlling the motor to drive the bed body to move downwards vertically.

10. The drive device according to claim 8, wherein the first power interruption component is a horizontal clutch, and the second power interruption component is a vertical clutch; and
the controller is used for:
acquiring a horizontal position and a vertical position of the bed body;
when the horizontal position is not in an original point, and the vertical position is in the highest position, receiving the operating instruction;
when the operating instruction is a first operating instruction, controlling the horizontal clutch to be pulled in, controlling the vertical clutch to be disconnected, and controlling the motor to drive the bed body to depart from the original point; and
when the operating instruction is a second operating instruction, controlling the horizontal clutch to be pulled in, controlling the vertical clutch to be disconnected, and controlling the motor to drive the bed body to move to the original point.

11. The drive device according to claim 8, wherein the first power interruption component is a horizontal clutch, and the second power interruption component is a vertical clutch; and
the controller is used for:
acquiring a horizontal position and a vertical position of the bed body;
when the horizontal position is in an original point, and the vertical position is in the highest position, receiving the operating instruction;
when the operating instruction is a first operating instruction, controlling the horizontal clutch to be pulled in, controlling the vertical clutch to be disconnected, and controlling the motor to drive the bed body to depart from the original point; and
when the operating instruction is a second operating instruction, controlling the horizontal clutch to be disconnected, controlling the vertical clutch to be pulled in, and controlling the motor to drive the bed body to move downwards vertically.

12. The drive device according to claim 8, wherein the first power interruption component and the second power interruption component are second gear cases; and the controller is used for:
acquiring a horizontal position and a vertical position of the bed body;
when the horizontal position is not in an original point, and the vertical position is in the highest position, receiving the operating instruction;
when the operating instruction is a first operating instruction, controlling an input gear of the second gear case to be engaged with a first power interruption gear, and controlling the motor to drive the bed body to depart from the original point; and
when the operating instruction is a second operating instruction, controlling the input gear of the second gear case to be engaged with the first power interruption gear, and controlling the motor to drive the bed body to move towards the original point.

13. The drive device according to claim 8, wherein the first power interruption component and the second power interruption component are second gear cases; and the controller is used for:
acquiring a horizontal position and a vertical position of the bed body;
when the horizontal position is in an original point, and the vertical position is not in the highest position, receiving the operating instruction;
when the operating instruction is a first operating instruction, controlling an input gear of the second gear case to be engaged with a second power interruption gear, and controlling the motor to drive the bed body to move upwards vertically; and
when the operating instruction is a second operating instruction, controlling the input gear of the second gear case to be engaged with the second power interruption gear, and controlling the motor to drive the bed body to move downwards vertically.

14. The drive device according to claim 8, wherein the first power interruption component and the second power interruption component are second gear cases; and
the controller is used for:
acquiring a horizontal position and a vertical position of the bed body;
when the horizontal position is in an original point, and the vertical position is in the highest position, receiving the operating instruction;
when the operating instruction is a first operating instruction, controlling an input gear of the second gear case to be engaged with the first power interruption gear, and controlling the motor to drive the bed body to depart from the original point; and
when the operating instruction is a second operating instruction, controlling the input gear of the second gear case to be engaged with the second power interruption gear, and controlling the motor to drive the bed body to move downwards vertically.

15. A hospital bed, comprising: a bed body, a first transmission mechanism, a second transmission mechanism, and the drive device according to claim 1.

16. A magnetic resonance imaging system, comprising: the hospital bed according to claim 15.
